(19) United States
(12) Patent Application Publication
(10) Pub. No.: US 2005/0262568 A1
(43) Pub. Date: Nov. 24, 2005

(54) System and method for managing access to protected content by untrusted applications

(76) Inventors: Mark D. Hansen, Buffalo Grove, IL (US); Richard T. Chow, Santa Clara, CA (US); Kevin C. Mowry, Irving, TX (US); Dwight R. Smith, Grapevine, TX (US); James P. Warden, Ft. Worth, TX (US)

Correspondence Address: MOTOROLA INC, 600 NORTH US HIGHWAY 45, ROOM AS437, LIBERTYVILLE, IL, 60048-5343, US

(21) Appl. No.: 10/848,340

(22) Filed: May 18, 2004

(51) Int. Cl. H04L 9/32; G06F 11/30; G06F 12/14; H04L 9/00

(52) U.S. Cl. 726/26; 713/193

(57) ABSTRACT

There is provided a communication device, and a method thereof, for managing access to protected content. The communication device comprises an application (302), a trusted file system service (316), a trusted agent (318) and a trusted content renderer (320). The application (302) requests performance of an action for the protected content (306). The trusted file system service (316) identifies the protected content (306) to the application (302). The trusted agent (318) identifies rights associated with the protected content (306) to the application (302). The trusted content renderer (320) performs the action in response to determining that the application (302) is an untrusted application having sufficient rights to perform the action.

### FIELD OF THE INVENTION

The present invention relates generally to the field of Digital Rights Management (“DRM”). In particular, the present invention relates to systems and methods for managing access to DRM protected content.

### BACKGROUND OF THE INVENTION

As content is increasingly being authored and delivered in digital form, content distributors are turning to systems utilizing Digital Rights Management (“DRM”) methods to protect their works. In these systems, a distributor can enumerate and grant the rights extended to the recipient in regards to using the content. Each system relies upon a secure environment in which the content is used to ensure that the permissions granted by the rights are obeyed. The system and associated rights may be used to prevent the unauthorized duplication or modification of the works. In most DRM implementations, these rights are expressed in a “rights object” which can be packaged together with the content or distributed separately. The content can be delivered in either plaintext or encrypted form.

With the release of the industry standard Open Mobile Alliance DRM (v1.0) specification, cellular phones supporting DRM protected content are becoming more prevalent. The DRM content has multiple methods to become resident on the device. It could be preloaded on the phone at time of manufacture, downloaded to the phone over the cellular network, or transferred by a computer to the phone through cable-based or wireless connections. Once on the phone, the DRM content may be contained within a secure environment in which the rights accompanying DRM protected content are enforced through software security. This security prevents the user and unauthorized applications from using the protected content in a manner inconsistent with the granted rights.

For existing systems that utilize DRM methods, applications that use DRM content must abide by the rights associated with that content and untrusted applications cannot be given direct access to the content. Applications that do have access to the content are deemed “trusted” by the manufacturer, cellular operator, or other authority. A “trusted” designation for a software application can be implemented and recognized by the mobile operating system through a variety of methods, such as possession of a digital certificate or file token.

However, the need of a “trusted” status to access DRM content is a hindrance for most application developers. Most cellular phones support a means for developers to create software that can be dynamically loaded and executed. It is desirable to give these developers a method to utilize resident DRM protected content within their applications. Yet, these developers cannot be inherently trusted to write applications that abide by DRM content rights, and it is not always feasible for a trusted authority (i.e., manufacturer or operator) to analyze the application for DRM compliance in order to give it trusted status.

Accordingly, there is need for a system and method for permitting untrusted application developers to create software that may utilize DRM content in a safe and compliant manner.

### BRIEF DESCRIPTION OF THE DRAWINGS

FIG. 1 is a block diagram of a wireless communication system in accordance with the present invention.

FIG. 2 is a block diagram illustrating exemplary components that may be utilized by a communication device of the wireless communication system of FIG. 1.

FIG. 3 is a block diagram illustrating an exemplary system architecture that may be utilized by a communication device of the wireless communication system of FIG. 1.

FIG. 4 is a block diagram illustrating an exemplary content format that may be utilized by the wireless communication system of FIG. 1.

FIG. 5 is a block diagram illustrating another exemplary content format that may be utilized by the wireless communication system of FIG. 1.

FIG. 6 is a block diagram illustrating yet another exemplary content format that may be utilized by the wireless communication system of FIG. 1.

FIG. 7 is a flow diagram illustrating an operation of the wireless communication system of FIG. 1.

### DETAILED DESCRIPTION OF THE PREFERRED EMBODIMENTS

There is provided a system and method for providing untrusted applications with the ability to utilize Digital Rights Management (“DRM”) content in a safe and compliant manner. The system and method utilize trusted proxies associated with protected content and a generalized interface between untrusted applications and these trusted proxies. The interface allows actions to be performed on the content by the untrusted applications which map to the permissions enumerated in the content rights object.

For one aspect, there is a communication device for managing access to protected content comprising an application, a trusted file system service, a trusted agent and a trusted content renderer. The application, such as an untrusted application, is configured to request performance of an action for the protected content. The trusted file system service is configured to identify the protected content to the application. The trusted agent is configured to identify rights associated with the protected content to the application. The trusted content renderer is configured to perform the action in response to determining that the application is an untrusted application having sufficient rights to perform the action.

For another aspect, there is a method of a communication device for managing access to protected content. A request is received from an application to perform an action for the protected content. The communication device then determines whether the application is a trusted application or an untrusted application and identifies rights associated with the protected content. Thereafter, the communication device performs the action in response to determining that the application is an untrusted application having sufficient rights to perform the action. On the other hand, the communication device does not perform the action in response to determining that the application is an untrusted application having insufficient rights to perform the action.

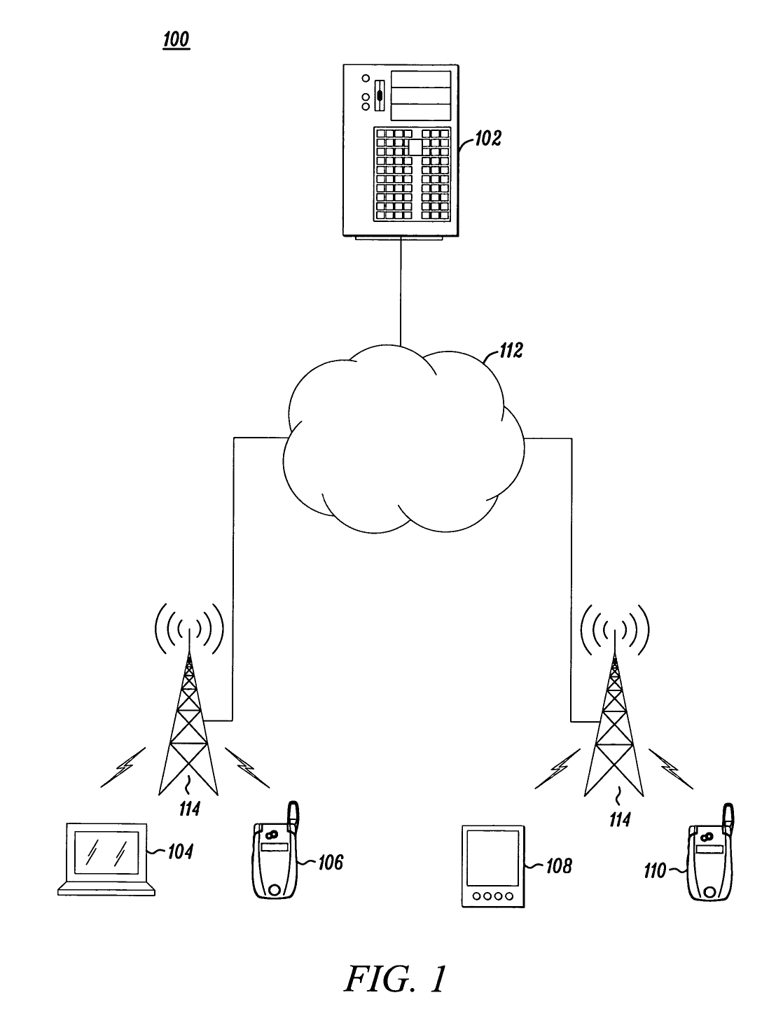

Referring to FIG. 1, there is provided a wireless communication system 100 in accordance with the present invention. The system 100 includes a server 102 and one or more communication devices 104, 106, 108, 110 being capable of communicating with each other and/or with the server. The communication devices 104, 106, 108, 110 may communicate with the server via a wired communication network or wireless communication network. The communication network may include one or more interoperability networks 112 and, for wireless communication, a plurality of wireless transceivers 114. Examples of the protocol or protocols that may be used by the wireless communication system include, but are not limited to, cellular-based communication protocols such as Advanced Mobile Phone System (AMPS), Code Division Multiple Access (CDMA), Time Division Multiple Access (TDMA), Global System For Mobile Communications (GSM), Integrated Digital Enhanced Network (iDEN), General Packet Radio Service (GPRS), Enhanced Data for GSM Evolution (EDGE), Universal Mobile Telecommunications System (UMTS), Wideband Code Division Multiple Access (WCDMA) and their variants. Communication between each communication device 104, 106, 108, 110 and the server is not limited to wired and wireless communication networks and, thus, other communication modes may be utilized. Examples of other communication modes include, but are not limited to, removable storage media, local wireless networks such as peer-to-peer or ad hoc networks (for example, Bluetooth and IEEE 802.11), and cable downloads from a PC.

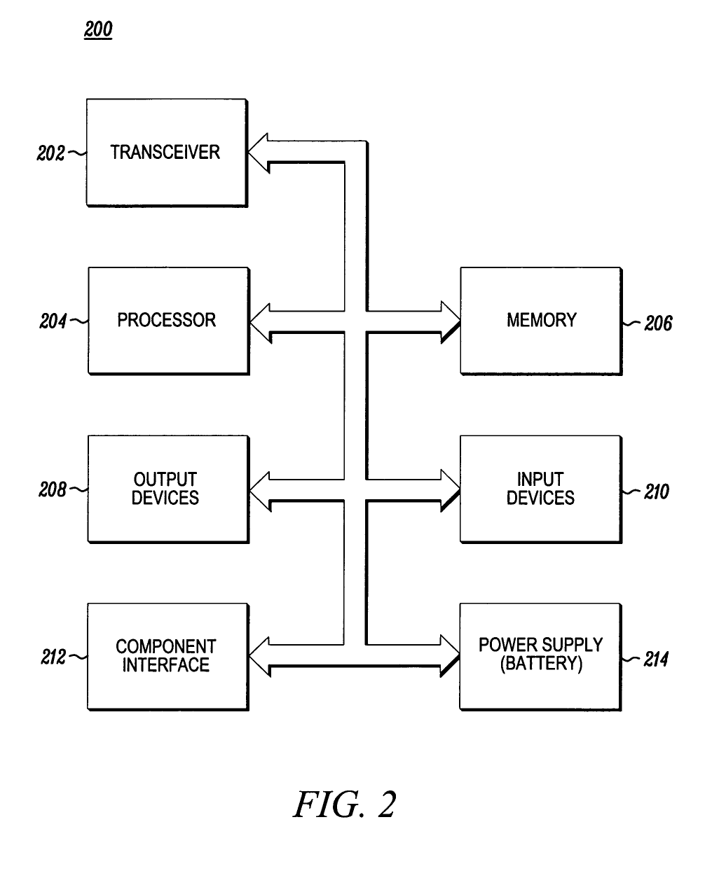

Referring to FIG. 2, there is provided a block diagram representing exemplary internal components 200 that may be utilized by a communication device of the wireless communication system 100. The exemplary embodiment includes one or more transceivers 202, a processor 204, a memory portion 206, one or more output communication devices 208, and one or more input communication devices 210. The internal components 200 may further include a component interface 212 to provide a direct connection to auxiliary components or accessories for additional or enhanced functionality. The internal components 200 preferably include a power supply 214, such as a battery, for providing power to the other internal components while enabling the communication device to be portable.

An exemplary function of the wireless communication device as represented by the internal components 200, upon reception of wireless signals, the internal components detect communication signals and a transceiver 202 demodulates the communication signals to recover incoming information, such as voice and/or data, transmitted by the wireless signals. After receiving the incoming information from the transceiver 202, the processor 204 formats the incoming information for one or more output communication devices 208. Likewise, for transmission of wireless signals, the processor 204 formats outgoing information, which may or may not be activated by the input communication devices 210, and conveys the outgoing information to the transceiver 202 for modulation to communication signals. The transceiver 202 conveys the modulated signals to a remote transceiver (not shown).

The input and output communication devices 208, 210 of the internal components 200 may include a variety of visual, audio and/or mechanical outputs. For example, the visual outputs of the output communication devices 208 may include a liquid crystal display and/or light emitting diode indicators, the audio outputs of the output communication devices may include a speaker, alarm and/or buzzer, and the mechanical outputs of the output communication devices may include a vibrating mechanism. Likewise, by example, the visual inputs of the input communication devices 210 may include an optical sensor (such as a camera), the audio inputs of the input communication devices may includes a microphone, and the mechanical inputs of the input communication devices may include keyboards, keypads, selection buttons, touch pads, touch screens, capacitive sensors, motion sensors, and switches.

The memory portion 206 of the internal components 200 may be used by the processor 204 to store and retrieve data. The data that may be stored by the memory portion 206 include, but is not limited to, operating systems, applications, and data. Each operating system includes executable code that controls basic functions of the communication device, such as interaction among the components of the internal components 200, communication with external communication devices via the transceiver 202 and/or the component interface 212, and storage and retrieval of applications and data to and from the memory portion 206. Each application includes executable code utilizes an operating system to provide more specific functionality for the communication device, such as file system service and handling of protected and unprotected data stored in the memory portion 206. Data is non-executable code or information that may be referenced and/or manipulated by an operating system or application for performing functions of the communication device.

The configuration of the memory portion 206 may be practiced in several different implementations including, but not limited to, memory resident on the communication device 104, 106, 108, 110, memory residing external to the communication device accessible via a wired or wireless link, and some combination thereof. The memory portion 206 may be internal and/or external to the processor 204. Memory external to the processor could be implemented using discrete memory integrated circuits mounted on the communication device hardware, but could also take the form of removable memory media accessible via a system bus interface or remotely located networked media accessible via a wired or wireless communication link.

The processor 204 may perform various operations to store, manipulate and retrieve information in the memory portion 206. Each component of the internal components 200 is not limited to a single component but represents functions that may be performed by a single component or multiple cooperative components, such as a central processing unit operating in conjunction with a digital signal processor and one or more input/output processors. Likewise, two or more components of the internal components 200 may be combined or integrated so long as the functions of these components may be performed by the communication device.

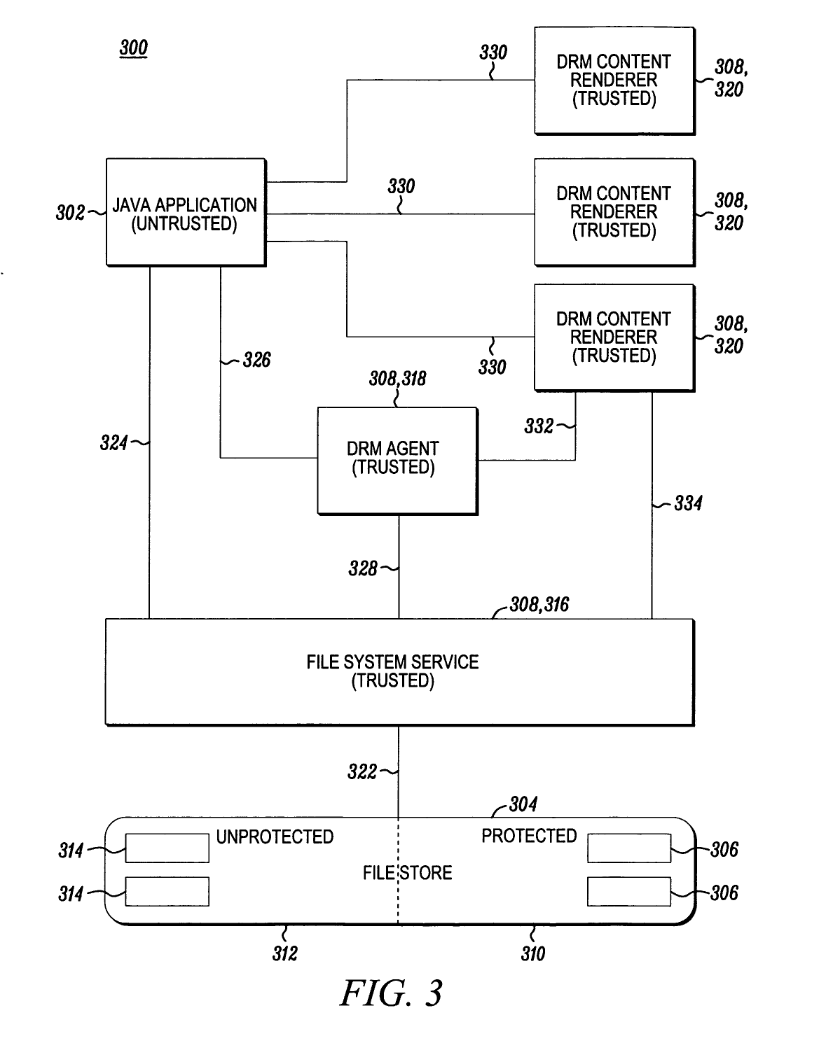

FIG. 3 is a block diagram illustrating an exemplary system architecture 300 that may be utilized by a communication device, such as communication devices 104, 106, 108, 110. In accordance with the present invention, the embodiment represented by FIG. 3 allows untrusted applications, such as those created by third-party developers and downloaded to a communication device 104, 106, 108, 110, to utilize Digital Rights Management-protected (DRM protected) content. For this embodiment, the system architecture 300 includes one or more untrusted applications 302, a file store 304 for storing one or more DRM protected content 306, and one or more trusted applications 308 for managing access of each DRM protected content by the untrusted application.

The file store 304 may include a protected region 310 and an unprotected region 312 within the communication device's memory portion 206. Accordingly, the file store 304 may store unprotected content 314 that may be accessed by each untrusted application 302 without restriction by the DRM protection operations of the trusted applications 308. For example, the unprotected region 312 may be accessible to any general software component running on the communication device 104, 106, 108, 110, and the protected region 310 may only be accessible via processes authorized by the trusted applications 308. It is to be understood that these regions 310, 312 are virtual in nature and may or may not be physically separated in the memory portion 206. The protected region 310 is restricted through a combination of file group permissions and digitally signed certificates managed by the trusted applications 308. System level processes, such as those trusted processes integral to the operating system, may be associated with a privileged group that may access the protected region 310. Other software components may receive authorization from the trusted applications 308 by being associated with a digitally signed certificate which proves its trusted status.

The trusted applications 308 may include a variety of components. For the embodiment represented by FIG. 3, the trusted applications 308 include a file system service 316, a DRM agent 318, and one or more DRM content renderers 320. The file system service 316 is a trusted component that controls access to DRM protected content 306 and the unprotected content 314 in the protected and unprotected regions 310, 312, respectively, by the untrusted application 302, the DRM agent 318 and/or the DRM content renderers 320. Each untrusted application 302 may use a trusted proxy, i.e., the DRM agent 318, to discover each DRM protected content 306 resident in the protected region 310 or the file system server 316 through interface 324. Each untrusted application 302 may also query the DRM agent 318 for rights and permissions associated with each DRM protected content 306.

Untrusted applications 302 can discover and request the DRM content renderers 320 on the communication device 104, 106, 108, 110 to perform operations on the DRM protected content 306. Even though a communication device 104, 106, 108, 110 may contain several renderers for different types of content, such as JPEG image, MPEG4 video, MIDI ringtone, and the like, the interface between the untrusted applications 302 and the DRM content renderer 320 can be generalized to map to certain operations, such as “play”, “print”, “display”, and “execute”. The DRM content renderers 320 may verify through the DRM agent 318 that the communication device 104, 106, 108, 110 has sufficient permissions to perform the operation on the requested DRM protected content 306 and start the operation. When the operation has been completed, the DRM content renderer or renderers 320 may notify the DRM agent 318 that the operation has been completed. The DRM agent 318 may then update stateful rights (access counter, intervals) within the file system. It should be noted that file metadata schemes may be used to track stateful rights via a content access counter and interval constraints.

Access to each DRM protected content by each untrusted application 302 may vary from embodiment-to-embodiment so long as the group of trusted applications 308 manages access of each DRM protected content 306. For example, plain text access to each DRM protected content 306 by each untrusted application 302 may be protected by a combination of Java-based OS architecture, file system security, and trust establishment. For this example, Java virtual machine (JVM) of the Java-based OS architecture may prevent each untrusted application 302 from accessing the memory areas of each DRM protected content 306 and the trusted applications 308. File permissions and file system daemon application programming interfaces (API's) prevent each untrusted application 302 from accessing a DRM protected portion of the file store 304.

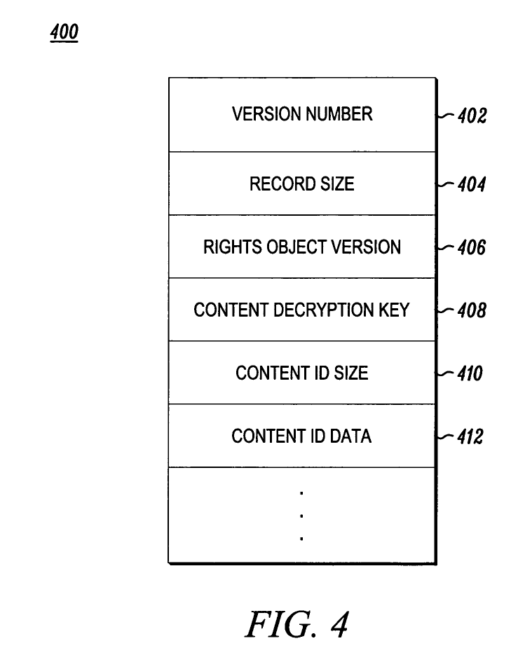

FIG. 4 is a block diagram illustrating an exemplary rights object format of a header and associated content that may be utilized by the wireless communication system 100. Prior to being stored on the protected region 310, the DRM protected content 306 may contain a rights object that is in a particular format, such as a XML or WBXML format. In addition, the system architecture 300 may convert objects to a compact binary form which minimizes memory requirements and maximizes processing efficiency.

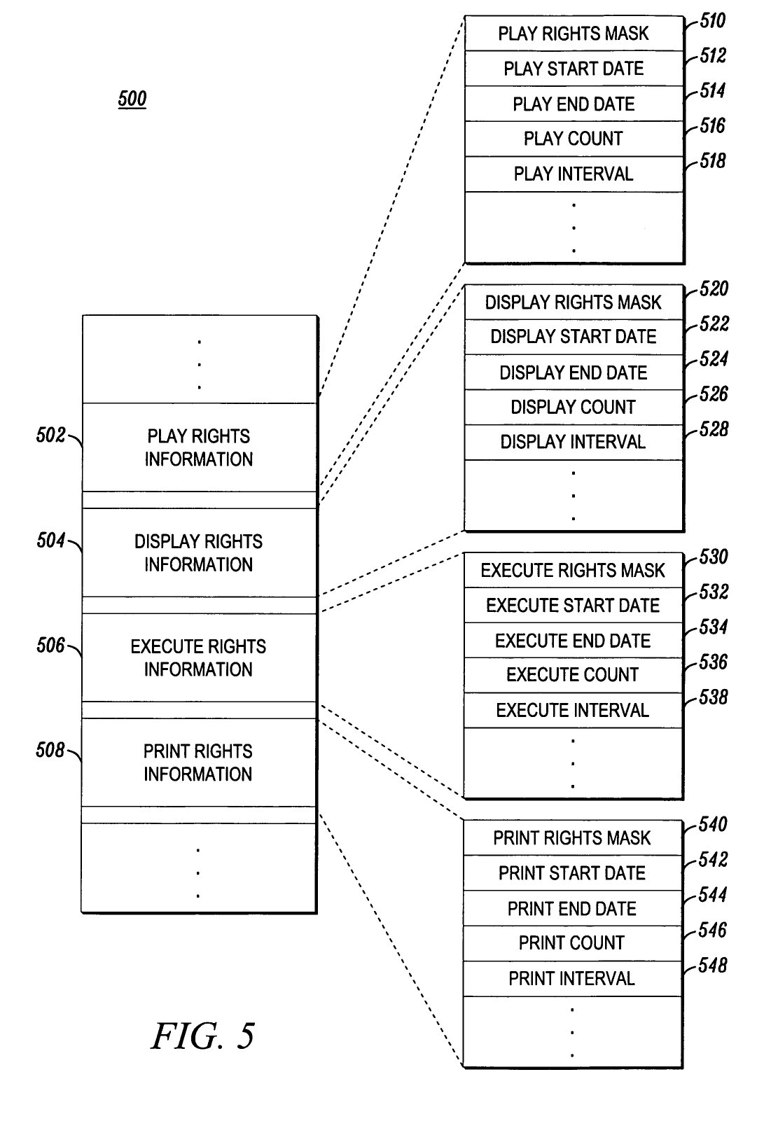

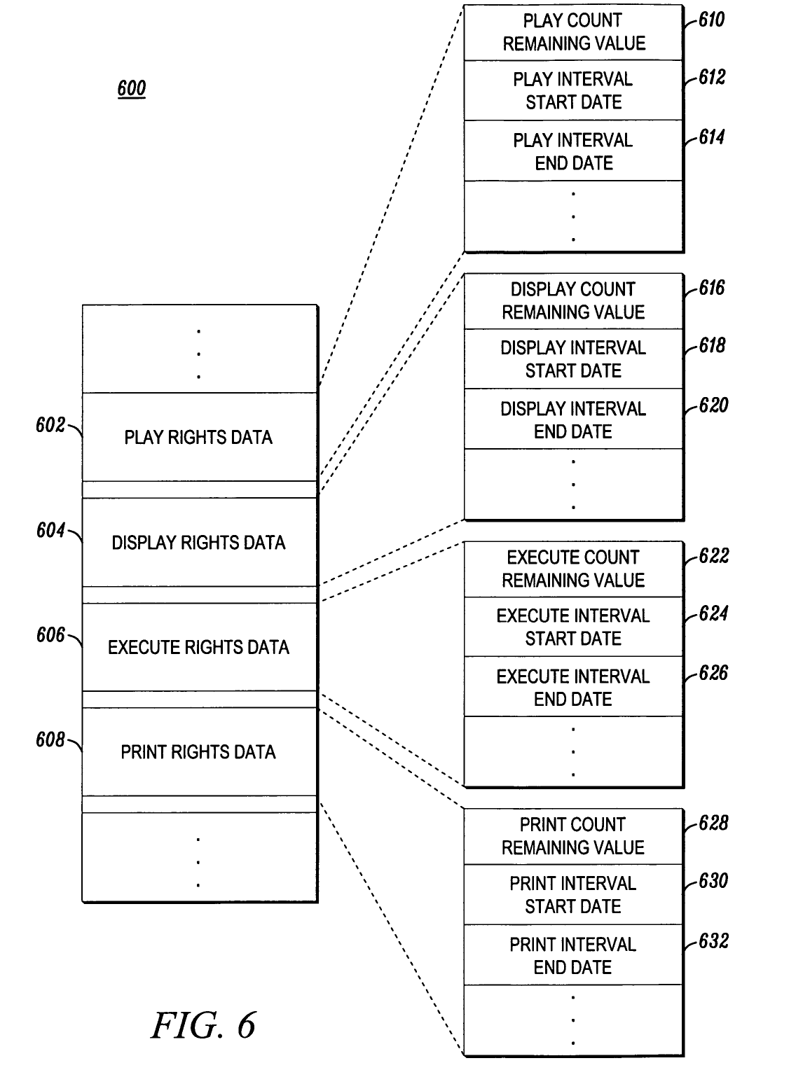

A rights object associated with content that has never been accessed initially includes read-only data. Examples of read-only data are shown in FIGS. 4 and 5 and include, but are not limited to, common data, such as content identification, content decryption key and permissions, as well as constraint data associated with each permission, such start date, end date, count and interval. Permissions are represented by their presence or absence (one for each permission) signifying that the permission is granted for a specific action if the permission is present or denied if the permission is absent. Examples of specific actions include, but are not limited to, “play”, “display”, “execute” and “print”. Once content has been accessed for the first time, an additional read-write section may be added to the rights object, depending on whether particular permission constraints are being used. Examples of read-write data are shown in FIG. 6 and include, but are not limited to, additional constraint data associated with each permission, such as count remaining value, interval start date and interval end date.

Referring still to FIG. 4, each rights object is stored in a record 400. Multiple Rights Objects that are associated with the same content id may be stored in the same file or as separate records in a database. Each record 400 includes a record header and a rights object. Examples of the record header include, but are not limited to, a version number 402 for each record and a size 404 of the record by a predetermined measurement type, such as bytes. Examples of the rights object include, but are not limited, a version number 406 for the rights object, a content decryption key value 408, a content identification (CID) size 410 representing the length of the CID data in by a predetermined measurement type such as bytes, a CID data 412 representing a content identifier having a length corresponding to the CID size, rights information (described below in reference to FIG. 5), and rights data (described below in reference to FIG. 6).

FIG. 5 is a block diagram illustrating an exemplary rights object format of read only permissions that may be utilized by the wireless communication system 100. As described above, a rights object associated with content that has never been accessed initially includes read-only data. The rights associated with a particular content object are delineated on a per action basis, such as “play”, “display”, “execute”, and “print”. Thus, examples of rights information 500 include play rights information 502, display rights information 504, execute rights information 506 and print rights information 508. The play rights information 502 may include a play rights mask 510, a play start date 512, a play end date 514, a play count 516 and a play interval 518. The display rights information 504 may include a display rights mask 520, a display start date 522, a display end date 524, a display count 526 and a display interval 528. The execute rights information 506 may include a execute rights mask 530, a execute start date 532, a execute end date 534, a execute count 536 and a execute interval 538. The print rights information 508 may include a print rights mask 530, a print start date 532, a print end date 534, a print count 536 and a print interval 538.

For each rights information 502, 504, 506, 508, the corresponding rights mask 510, 520, 530, 540 may have variable settings. For example, each rights mask 510, 520, 530, 540 may have a first setting indicating that permission is granted, a second setting indicating that there is a date and/or time constraint, a third setting indicating that there is a count constraint, and a fourth setting indicating that there is an interval constraint. Also, each start date 512, 522, 532, 542 and each end date 514, 524, 534, 544 may be provided in various formats, such as year, month, day of month, hour of day, minute of hour and/or second of minute. Similarly, each interval 518, 528, 538, 548 may be provided in various forms, such as years, months, days, hours, minutes and/or seconds. Further, each count 516, 526, 536, 546 may be provided in various forms, but is preferably provided as an integer value.

FIG. 6 is a block diagram illustrating an exemplary rights object format of read write data that may be utilized by the wireless communication system 100. As described above, an additional read-write section may be added to the rights object after content has been accessed for the first time, depending on whether particular permission constraints are being used. For example, a count constraint may be used on the “play” action to limit the number of times a content object can be played. Once the content is played for the first time, a counter must be created within the rights object to track the number of times the content has been played. Subsequent accesses must then increment this number, unless the count has reached its prescribed maximum limit.

Examples of rights data 600 include play rights data 602, display rights data 604, execute rights data 606 and print rights data 608. The play rights data 602 may include a play count remaining value 610, a play interval start date 612 and a play interval end date 614. The display rights data 604 may include a display count remaining value 616, a display interval start date 618 and a display interval end date 620. The execute rights data 606 may include an execute count remaining value 622, an execute interval start date 624 and an execute interval end date 626. The print rights data 608 may include a print count remaining value 628, a print interval start date 630 and a print interval end date 632.

For each rights data 602, 604, 606, 608, the corresponding count remaining value 610, 616, 622, 628 may be provided in variable forms, but is preferably provided as an integer value. Also, each interval start date 612, 618, 624, 630 and each interval end date 614, 620, 626, 632 may be provided in various formats, such as year, month, day of month, hour of day, minute of hour and/or second of minute.

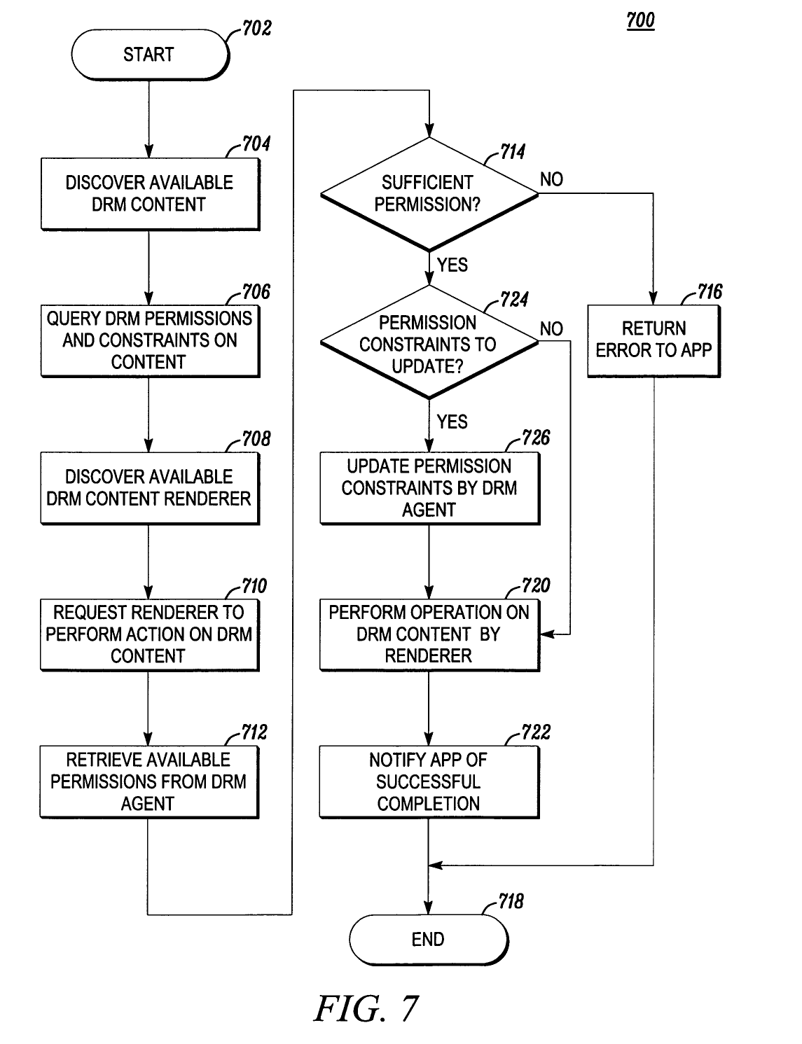

FIG. 7 is a flow diagram illustrating an operation 700 of the wireless communication system of FIG. 1. In particular, the operation 700 is a sequence of components and interfaces involved in allowing an untrusted application 302 to access the DRM protected content 306. After beginning at step 702, an untrusted application 302 discovers DRM protected content 306 for consumption at step 704. For one embodiment, discovery takes the form of file querying APIs, which may be provided by the file system service 316 directly (i.e., through interfaces 322, 324) or indirectly through the DRM agent 318 acting as a proxy to the file system service (i.e., through interfaces 326, 328, 322). The DRM agent is a trusted software component that is responsible for the enforcing and management of granted rights and permissions associated with rights objects and DRM protected content 306.

If the file system service 316 allows querying of the protected region 310 directly, then the protected region must be careful to allow only directory-read access to the DRM protected content 306. For example, the untrusted application 302 may be allowed to view listings of the DRM protected content 306 in the protected region 310, but may not perform any other action, such reading, writing and/or deleting, to the content. Once the untrusted application 302 has identified a particular DRM protected content for consumption, it may optionally query the DRM agent 318 for the associated rights available on that content (i.e., interfaces 326, 328, 322) at step 706. For example, the untrusted application 302 may pass to the DRM agent 318 a handle to the content file or string containing the file location.

Based upon the rights and privileges reported by the DRM agent 318, the untrusted application 302 may determine whether to consume the DRM protected content 306 or not. If the untrusted application 302 decides to access the DRM protected content 306, then it first must discover a DRM content renderer that is appropriate for the content type at step 708. For example, the discovery call may go to a framework content which manages content services. Each DRM content renderer 320 is a trusted service that has identified itself with the communication device 104, 106, 108, 110 as being associated with a particular content type (such as MP3 or WAV for sound files, HTML for an HTML document, and the like). For example, each DRM content renderer 320 may specify this association through declaration of a MIME type. When an appropriate DRM content renderer 320 has been discovered, the application informs the renderer of the content it wishes to access and the desired action it wants to perform (through interface 330) at step 710. The action corresponds to one or more defined actions (such as play, display, execute, and print) used within the rights object.

The DRM content renderer 320 verifies that the untrusted application 302 has sufficient rights to perform this operation by checking with the DRM agent 318 (through interfaces 332, 328, 322) at step 712. Note that this step is similar to step 706 above, but step 706 is an optional step on the behalf of the untrusted application 302 whereas step 712 for verifying with the DRM agent 318 is a necessary step to enforce the DRM permissions. The DRM agent 318 thereafter determines whether the untrusted application 302 has sufficient rights to perform the operation at step 714. If the DRM agent 318 reports to the DRM content renderer 320 that there is insufficient permission (through interface 332), then the renderer reports an error message back to the untrusted application 302 citing insufficient permission (through interface 330) at step 716, and the operation 700 terminates at step 718.

If the DRM agent 318 reports to the DRM content renderer 320 that the untrusted application 302 does indeed have sufficient rights (through interface 332), then the renderer may commence with the operation (through interfaces 334, 322) at step 720. Once the requested operation has been completed, the DRM content 320 renderer may report back a successful completion to the untrusted application 302 (through interface 330) at step 722, and the operation 700 terminates at step 718.

For another embodiment, some rights object fields such as count and interval constraints may require updating. Stateful rights fields or constraints may be updated before, while or after the operation is performed. For example, the DRM agent 318 may determine whether any permission constraints need to be updated at step 724. If any fields within the rights object require updating, then the DRM agent 318 may access the rights object and update them (through interfaces 328, 322) at step 726. After any relevant fields in the rights object have been updated or if there are no fields within the rights object that require updating, then the DRM content renderer 320 reports back a successful completion to the untrusted application 302 (through interface 330) at step 722, and the operation 700 terminates at step 718.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method of a communication device for managing access to protected content comprising:
receiving a request from an untrusted application to perform an action for the protected content; and
performing the action in response to determining that the untrusted application has sufficient rights to perform the action.

2. The method of claim 1, further comprising identifying rights associated with the protected content.

3. The method of claim 1, further comprising notifying the untrusted application in response to determining that the untrusted application has insufficient rights to perform the action.

4. A method of a communication device for managing access to protected content comprising:
receiving a request from an application to perform an action for the protected content;
determining whether the application is a trusted application or an untrusted application and identifying rights associated with the protected content; and
performing the action in response to determining that the application is an untrusted application having sufficient rights to perform the action.

5. The method of claim 4, wherein the action includes at least one of play, display, execute and print.

6. The method of claim 4, further comprising providing an error message to the application in response to determining that the application is an untrusted application having insufficient rights to perform the action.

7. The method of claim 4, further comprising:
identifying a trusted entity associated with the protected content; and
controlling the protected content via the trusted entity based on at least one request received from the untrusted application.

8. The method of claim 4, further comprising protecting the protected content using a digital rights management scheme.

9. The method of claim 4, further comprising identifying available protected content.

10. The method of claim 4, further comprising determining whether to utilize the protected content based on the rights associated with the protected content.

11. The method of claim 4, further comprising receiving notification that the action has been completed.

12. The method of claim 4, further comprising updating permission constraints subsequent to initiating the action.

13. The method of claim 4, further comprising notifying the application of successful completion.

14. The method of claim 4, wherein determining whether the application is a trusted application or an untrusted application occurs before identifying rights associated with the protected content.

15. The method of claim 4, wherein determining whether the application is a trusted application or an untrusted application occurs after identifying rights associated with the protected content.

16. A communication device for managing access to protected content comprising:
an application configured to request performance of an action for the protected content;
a trusted file system service configured to identify the protected content to the application;
a trusted agent configured to identify rights associated with the protected content to the application; and
a trusted content renderer configured to perform the action in response to determining that the application is an untrusted application having sufficient rights to perform the action.

17. The communication device of claim 16, further comprising a file store configured to distinguish the protected content from unprotected content.

18. The communication device of claim 16, wherein the action includes at least one of play, display, execute and print.

19. The communication device of claim 16, wherein the trusted content renderer provides an error message to the application in response to determining that the application is an untrusted application having insufficient rights to perform the action.

20. The communication device of claim 16, wherein the protected content protected using a digital rights management scheme.

21. The communication device of claim 16, wherein the trusted content renderer notifies the trusted agent that the action has been completed.

22. The communication device of claim 16, the trusted agent updates permission constraints subsequent to initiating the action.

23. The communication device of claim 16, wherein trusted content renderer notifies the application of successful completion.
